(19) United States
(12) Patent Application Publication
(10) Pub. No.: US 2025/0104297 A1
(43) Pub. Date: Mar. 27, 2025

(54) STORAGE MEDIUM, IMAGE CREATION SUPPORT SYSTEM, AND IMAGE CREATION SUPPORT METHOD

(71) Applicant: KONICA MINOLTA, INC., Tokyo (JP)

(72) Inventors: Mikihiro YAMAKAWA, Tokyo (JP); Taro TAKECHI, Tokyo (JP); Sachiko HIRANO, Tokyo (JP); Mieko MITA, Tokyo (JP); Ken MIYAZAKI, Sagamihara-shi (JP); Miku KANNO, Tokyo (JP)

(73) Assignee: KONICA MINOLTA, INC., Tokyo (JP)

(21) Appl. No.: 18/829,863

(22) Filed: Sep. 10, 2024

(30) Foreign Application Priority Data
Sep. 26, 2023 (JP) 2023-161803

(51) Int. Cl. G06T 11/00

(52) U.S. Cl. CPC G06T 11/001; G06T 2200/24

(57) ABSTRACT

A non-transitory computer-readable storage medium stores a program causing a computer to perform: first reception of receiving first text data; first transmission of transmitting the first text data to an image generation AI apparatus; first image obtainment of obtaining, from the image generation AI apparatus, first image data for the first text data, the first image data being generated by the image generation AI apparatus; and external apparatus transmission of transmitting the first text data and the first image data associated with one another to an external apparatus.

### BACKGROUND OF THE INVENTION

### Technical Field

The present invention relates to a storage medium, an image creation support system, and an image creation support method.

### Description of Related Art

Conventionally, when a salesperson of a printing company and a customer bounce ideas about an image of a print product off each other, the customer often does not clearly have a mental picture that he/she wants to embody. Therefore, the salesperson needs to pull out the customer's mental picture from “none”.

Therefore, the salesperson creates images several times and asks the customer to check the images. Thus, the salesperson finds the direction of design, and then submits an image to a designer to complete a formal image.

Meanwhile, there is known image generation artificial intelligence (AI), such as Stable Diffusion, which generates an image by a text being input.

Further, in Japanese Unexamined Patent Publication No. 2021-168078, there is disclosed a design support learning model that receives an input image of a natural object and outputs an output image obtained by mixing the input image with an artifact.

### SUMMARY OF THE INVENTION

In the current situation as described above, there are cases where when the salesperson shows an image created based on the bounced-off ideas to the customer, it is different from the customer's mental picture and redoing is necessary.

Thus, in order to find the direction of the design which can satisfy the customer, the salesperson has to create an image many times. Therefore, the man-hours and the cost have been burdens on the customer and the salesperson.

By generating an image using the image generation AI or the like as described above, it is possible to efficiently determine the direction of a design draft that the customer can agree with.

However, if only the image thus generated is provided to the designer, the image includes both a portion with the customer's fastidiousness and a portion that the customer does not mind the designer's modification.

Therefore, it is difficult for the designer to grasp which part is customer's favorite and which part is correctable. As a result, image exchange may be performed many times between the customer and the designer.

Objects of the present invention include more efficiently creating an image that meets a customer's request.

To achieve at least one of the abovementioned objects, according to an aspect of the present invention, a non-transitory computer-readable storage medium reflecting one aspect of the present invention stores a program causing a computer to perform:
first reception of receiving first text data;
first transmission of transmitting the first text data to an image generation AI apparatus;
first image obtainment of obtaining, from the image generation AI apparatus, first image data for the first text data, the first image data being generated by the image generation AI apparatus; and
external apparatus transmission of transmitting the first text data and the first image data associated with one another to an external apparatus.

According to an aspect of the present invention, an image creation support system reflecting one aspect of the present invention includes:
a hardware processor that receives first text data; and
a transmitter that transmits the first text data to an image generation AI apparatus,
wherein the hardware processor obtains, from the image generation AI apparatus, first image data for the first text data, the first image data being generated by the image generation AI apparatus, and
wherein the transmitter transmits the first text data and the first image data associated with one another to an external apparatus.

According to an aspect of the present invention, an image creation support method reflecting one aspect of the present invention is performed by an image creation support system, and includes:
receiving first text data;
transmitting the first text data to an image generation AI apparatus;
obtaining, from the image generation AI apparatus, first image data for the first text data, the first image data being generated by the image generation AI apparatus; and
transmitting the first text data and the first image data associated with one another to an external apparatus.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a block diagram illustrating a configuration of an image creation support system;

FIG. 2 is a flowchart of an image creation support process;

FIG. 3 is an image diagram of an image creation support screen;

FIG. 4 is an image diagram of the image creation support screen;

FIG. 5 is an image diagram of a record screen;

FIG. 6 is an image diagram of an image creation support screen;

FIG. 7 is an image diagram of an image creation support screen; and

FIG. 8 is a flowchart of the image creation support process.

### DETAILED DESCRIPTION

Hereinafter, one or more embodiments of the present invention will be described with reference to the drawings. However, the scope of the present invention is not limited to the embodiments below or those shown in the drawings.

### <Image Creation Support System 100>

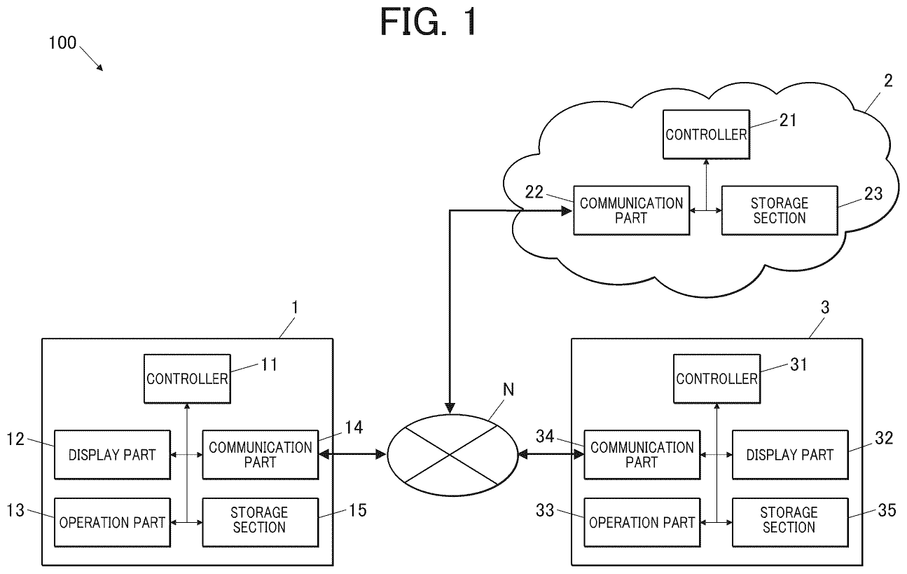

First, a configuration of an image creation support system 100 will be described with reference to FIG. 1. As illustrated in FIG. 1, the image creation support system 100 includes an image creation support apparatus 1, a cloud server 2, and an external apparatus 3. The image creation support apparatus 1, the cloud server 2, and the external apparatus 3 transmit and receive information to and from each other via a communication network N. The image creation support apparatus 1 is an apparatus that supports image creation by a user such as a salesperson of a printing company or a customer thereof. Specifically, the image creation support apparatus 1 displays an image generated by the cloud server 2 on the basis of a concept of text data input by the user, and receives various operations performed on the image by the user.

The cloud server 2 is an image generation AI apparatus that generates an image based on the concept of the text data. The cloud server 2 is also an apparatus that analyzes the below-described saliency of the created image. Note that the cloud server 2 may be an on-premises apparatus.

The external apparatus 3 is an apparatus on which a designer displays a created image, concept, or the like.

The communication network N is a local area network (LAN), a wide area network (WAN), the Internet, or the like.

### <Image Creation Support Apparatus 1>

Next, a configuration of the image creation support apparatus 1 will be described with reference to FIG. 1. As illustrated in FIG. 1, the image creation support apparatus 1 includes a controller 11 (hardware processor), a display part 12 (display), an operation part 13, a communication part 14 (transmitter), and a storage section 15.

The controller 11 includes a central processing unit (CPU), a random access memory (RAM), and the like. The CPU of the controller 11 reads various programs stored in the storage section 15, develops the programs in the RAM, executes various processes in accordance with the developed programs, and controls the operation of each unit of the image creation support apparatus 1.

The display part 12 is configured by a monitor such as a liquid crystal display (LCD), and displays various screens and the like in accordance with an instruction of a display signal input from the controller 11.

The operation part 13 is a keyboard including cursor keys, number input keys, various function keys, and the like, a pointing device such as a mouse, a touch screen stacked on the surface of the display part 12, or the like. The operation part 13 is configured to be operable by an operator. The operation part 13 outputs various signals based on operations performed by the operator to the controller 11.

The communication part 14 can transmit and receive various signals and various data to and from other apparatuses and the like connected via the communication network N.

The storage section 15 is configured by a nonvolatile semiconductor memory, a hard disk, or the like, and stores various programs to be executed by the controller 11, parameters required for execution of the programs, various data, and the like.

### <Cloud Server 2>

Next, a configuration of the cloud server 2 will be described with reference to FIG. 1. As illustrated in FIG. 1, the cloud server 2 includes a controller 21, a communication part 22, and a storage section 23.

The cloud server 2 has a function as an image generation AI and a function as a saliency analysis module.

The controller 21 includes a CPU, a RAM, and the like. The CPU of the controller 21 reads various programs stored in the storage section 23, develops the programs in the RAM, executes various processes in accordance with the developed programs, and controls the operation of each unit of the cloud server 2.

The controller 21 can extract design requirements from the concepts of the text data. The design requirements are elements included in the concept subdivided. For example, in a case where the concept is “simple miso sauce that tempts a young person living alone to make delicious boiled fish”, the controller 21 can extract, as the design requirements, “fish dish”, “boiled food”, “miso sauce”, “beginner”, “for young people”, and the like.

The controller 21 can create a design image by the image generation AI on the basis of the concept, the design requirements, and the image.

Here, examples of the image generation AI include Stable Diffusion, DALL E2, Midjourney, starryai, and Dream by WOMBO.

The controller 21 can analyze the saliency of the created design image. That is, the controller 21 can indicate the analysis result regarding saliency in the following cases. Specifically, this is a case where the evaluator (user or the like) wants to know whether a portion that he/she wants to make visually particularly conspicuous in a certain image has been made conspicuous. A state in which a portion that is desired to be visually particularly conspicuous has been made conspicuous is referred to as the portion having saliency. Another example is a case where the evaluator wants to know how to make the portion more conspicuous in the evaluation target image.

### <Saliency Analysis Technique>

Here, a saliency analysis method will be described.

First, details of the functions of the controller 21 will be described.

The controller 21 functions as a feature amount extraction section and a generation section.

The controller 21 as the feature amount extraction section extracts a low-order image feature amount and a high-order image feature amount from the obtained evaluation target image.

Note that a specific method by which the controller 21 as the feature amount extraction section extracts the low-order image feature amount and the high-order image feature amount from the evaluation target image will be described later.

Here, the low-order image feature amount is a physical image feature amount including, for example, color, brightness, direction (direction and shape of an edge), and the like, and is a component that guides a person's line of sight to watch the image extrinsically and passively. In the present embodiment, the low-order image feature amount is a concept broadly including at least one of contrast of color or brightness distribution, and a motion.

The impact given to a viewer of an image and the degree of gaze (conspicuousness, saliency) vary depending on factors such as the color contrast (for example, the color difference in the red-green direction and the color difference in the yellow-blue direction) used in each portion constituting the image, the distribution of the brightness contrast (brightness difference) in each portion, and the contrast in the direction (orientation).

For example, in a portion (boundary portion or the like) having a large color difference along the red-green direction or the yellow-blue direction, the line of sight is likely to gather and the saliency tends to increase.

In addition, for example, in a case where the whole is arranged in a certain direction but there is a portion arranged in a direction (edge direction) different from the certain direction, the line of sight tends to concentrate on the portion.

Furthermore, the evaluation target image is not limited to a still image, but may be a moving image. In a case where the evaluation target image is a moving image, various operations (motion, exercise) in the image also affect the degree of gaze of the viewer. For example, in a case where in an image where the entirety moves at a substantially constant speed in a certain direction, only one portion moves at a different speed or a portion moves in a direction different from the other portions, the line of sight tends to concentrate on the portion.

The high-order image feature amount is a physiological and mental image feature amount that reflects the memory, experience, knowledge, and the like of a person, and is a component that guides the line of sight of a person to watch the image spontaneously and actively. More specifically, it is a component derived from the mental and psychological tendency of a person, the movement tendency of the line of sight, and the like, which are considered to have an influence on the impact given to a person who views an image and the degree of gaze (conspicuousness, saliency). In the present embodiment, the high-order image feature amount includes the degree of at least one of the position bias, the processing fluency, and the face component.

For example, the position bias includes the following tendency as the tendency of the movement of the line of sight. Specifically, it is a center bias in which the line of sight tends to concentrate on an object at the center of the image. Further, for example, it is a tendency in which in/on a magazine, a web page, or the like, the line of sight tends to move from the upper left to the lower right of the image, and the line of sight tends to concentrate on the upper left. Furthermore, it is a tendency in which when a vertically written document is viewed, the line of sight tends to move from the upper right to the lower left and tend to concentrate on the upper right. Furthermore, it is a tendency in which for example, when a case of visiting a store such as a supermarket is considered, the line of sight is tends to concentrate on a portion close to the height of the eyes in the layout of the store.

As described above, the position bias affects the degree of gaze (conspicuousness, saliency) of a person who views an image or the like.

Furthermore, the processing fluency generally indicates that a person easily processes something that is simple and easy to recognize, and processes, with difficulty, something that is complicated and difficult to understand. In the present embodiment, there is a tendency that the line of sight is easily directed to a portion which is easily recognized and has a high processing fluency in an image so that the portion is likely to be watched, and there is a tendency that a portion which is hardly recognized and has a low processing fluency is unlikely to be watched.

As described above, the processing fluency influences the degree of gaze (conspicuousness, saliency) of a person who views an image.

In the present embodiment, the degree of processing fluency includes those determined by at least one of complexity, a density of a depicted object(s), and a spatial frequency of a brightness distribution.

That is, the portion that is difficult to be recognized is a portion that is disordered and complicated, that is, a portion where objects and the like drawn in an image are densely present and difficult to recognized. A sudden change such as an edge occurs in an image at a portion or the like where objects or the like are disorderly crowded in the image, and the spatial frequency of the brightness distribution is high at such a portion. In a portion where the complexity, the density of the drawn objects, and the brightness distribution spatial frequency are too high, the processing fluency is low.

On the other hand, it is also difficult to read information from a portion where the complexity, the density of the drawn objects, and the spatial frequency of the brightness distribution are too low, that is, an area where information is not included, and the portion/area is hard to be processed by the human brain and tends not to be watched.

Further, when there is a portion recognized as a face in an image, the user generally tends to gaze at the portion. That is, a portion recognized as a face tends to have high saliency.

Furthermore, the high-order image feature amount may include a character or a font.

In a case where elements constituting an image are readable characters, the degree of gaze of a viewer varies depending on the type and size of the font. The font contains characters of a specific typeface, and there are various typefaces such as printed typeface, block typeface, and cursive typeface. The degree of attention of a viewer may vary depending on the font used for expression. In addition, a large character tends to draw more attention than a small character even in the same typeface.

The controller 21 as the generation section generates, for each type of image feature amount, a feature amount saliency map indicating saliency in the evaluation target image based on the image feature amount, and generates a saliency map by integrating all feature amount saliency maps.

A specific method by which the controller 21 serving as the generation section generates the saliency map will be described later.

The controller 21 performs a blurring process with a Gaussian filter on the evaluation target image. The blurring process is a process for reducing the resolution of an image. Specifically, an image group (a multi-resolution representation of an image, a Gaussian pyramid) in which a plurality of Gaussian filters having different degrees of blurring are applied to an evaluation target image in a stepwise manner is generated for each low-order image feature amount.

After generating the image group (Gaussian pyramid) for each image feature amount component, the controller 21 obtains (calculates) an inter-image difference of a different scale for each image feature amount element by using the multi-resolution representation.

In the process of calculating the inter-image difference, the controller 21 calculates at least one of a color difference and a brightness difference using an L*a*b* color space obtained by converting RGB data. The L*a*b* color space is more consistent with human color difference perception than the RGB color space. Therefore, calculating at least one of the color difference and the brightness difference by the L*a*b* color space produces the following effects. Specifically, the value of the brightness contrast or the chromaticity contrast extracted from the evaluation target image can be expressed by the brightness difference or the color difference suitable for human senses. Therefore, the saliency indicated by the finally obtained saliency map can be more closely matched with the human sense.

When the difference image is obtained, the controller 21 normalizes the difference image and combines the feature amount maps of all scales for each image feature amount component. Next, the controller 21 generates a feature amount saliency map corresponding to the feature amount map.

The feature amount saliency map when viewed for each low-order image feature amount is, in the case of the color component, a saliency map indicating that the saliency of a portion in which a color contrast (a color difference in a red-green direction or a yellow-blue direction) is greatly expressed is great. In the case of the brightness component, for example, the fact that the saliency of a boundary portion between a black screen portion and a white portion of a notebook computer is great is indicated as a map. In the case of the direction component, a portion having an edge of a notebook or a laptop computer is indicated as a portion having great saliency.

In the present embodiment, the processing fluency (complexity or the like), the position bias and the face component are extracted as the high-order image feature amount by the controller 21 as the feature amount extraction section.

Here, the processing fluency, the position bias and the face component are illustrated as the high-order image feature amount, but as described above, the high-order image feature amount is not limited thereto. The high-order image feature amount may include various elements (components) other than these.

As described above, the processing fluency can be measured by the degree of complexity, and can be analyzed and quantified using, for example, a method called fractal dimension. That is, the evaluation target image is divided into a plurality of meshes, and analysis is performed on which portion has a dense structure expressed by dots and which portion has a sparse structure. As a result, a portion having a high fractal dimension is evaluated as a complicated and disordered portion. In addition, a portion having a low fractal dimension is evaluated as a simple portion having a small amount of information.

Note that as described above, a ground portion where almost no information exists has a low fractal dimension, but is a portion to which little attention is paid and that has low saliency. For this reason, as the feature amount saliency map related to the processing fluency, a map in which the saliency is evaluated to be low in a ground portion having little information or an excessively complicated portion and the saliency is evaluated to be the highest in a moderately complicated portion is obtained.

Further, the controller 21 generates a feature amount saliency map of the position bias corresponding to a place or a direction where the line of sight is easily guided in consideration of a psychological characteristic of a person, according to the characteristics and type of the evaluation target image. The characteristics and type of the image are, for example, whether the image is an image to be put in/on a book or a web page, or an image to be inserted in a vertically written document.

For example, in a case where the evaluation target image is to be posted on a web page, the map has high saliency at the upper left of the screen and low saliency at the lower right thereof.

Furthermore, the controller 21 extracts an area that can be recognized as a face from the evaluation target image by using face area detection AI or the like, and generates a feature amount saliency map of the face component. In the feature amount saliency map of the face component, the saliency of the area that can be recognized as a face is high.

When the feature amount saliency maps are generated for the low-order and high-order image feature amounts, the controller 21 integrates the feature amount saliency maps. Then, the controller 21 calculates where the line of sight is directed as a whole when a person views the evaluation target image, and which portion has a high degree of attention or gaze.

In the process of integrating all the feature amount saliency maps, the controller 21 generates the saliency map such that the sum of the similarities between the saliency map and all the feature amount saliency maps becomes the maximum.

Specifically, the controller 21 generates the saliency map so as to satisfy Formula (1) below.

$$\begin{matrix}[ Math . 1 ] & \\ s = {arg max}_{s} {\sum }_{f} {{w}_{f} ( \frac{f \cdot s}{\vert f \vert \vert s \vert} )}^{2} & ( 1 )\end{matrix}$$

s: saliency map of array indexes rearranged as a column vector
f: feature amount saliency map of array indexes rearranged as a vertical vector
w_{f}: value of weighting for each image feature amount

Generating a saliency map such that Formula (1) above is satisfied allows the following saliency map to be generated.

Specifically, in a case where a plurality of feature amount saliency maps emphasizes the same portion in the evaluation target image, it is a saliency map that emphasizes the same portion to the same extent as the feature amount saliency maps.

A case where one feature amount saliency map excessively emphasizes a portion in the evaluation target image, and the other feature amount saliency maps do not emphasize the portion will be described. In this case, it is a saliency map that does not overemphasize the portion.

The description of the configuration of the cloud server 2 will be restarted.

The communication part 22 can transmit and receive various signals and various data to and from other apparatuses and the like connected via the communication network N.

The storage section 23 is configured by a nonvolatile semiconductor memory, a hard disk and/or the like, and stores various programs to be executed by the controller 21, parameters necessary for executing the programs, various data and the like.

### <External Apparatus 3>

Next, a configuration of the external apparatus 3 will be described with reference to FIG. 1. As shown in FIG. 1, the external apparatus 3 includes a controller 31, a display part 32, an operation part 33, a communication part 34, and a storage section 35.

The controller 31 includes a CPU, a RAM, and the like. The CPU of the controller 31 reads various programs stored in the storage section 35, develops the programs in the RAM, executes various processes in accordance with the developed programs, and controls the operation of each unit of the external apparatus 3.

The display part 32 is configured by a monitor such as an LCD, and displays various screens and the like in accordance with instructions of display signals input from the controller 31.

The operation part 33 is a keyboard including cursor keys, number input keys, various function keys, and the like, a pointing device such as a mouse, a touch screen stacked on the surface of the display part 32, and the like. The operation part 33 is configured to be operable by an operator. The operation part 33 outputs various signals based on operations performed by the operator to the controller 31.

The communication part 34 can transmit and receive various signals and various data to and from other apparatuses and the like connected via the communication network N.

The storage section 35 is configured by a nonvolatile semiconductor memory, a hard disk and/or the like, and stores various programs to be executed by the controller 11, parameters necessary for executing the programs, various data and the like.

### <Image Creation Support Process>

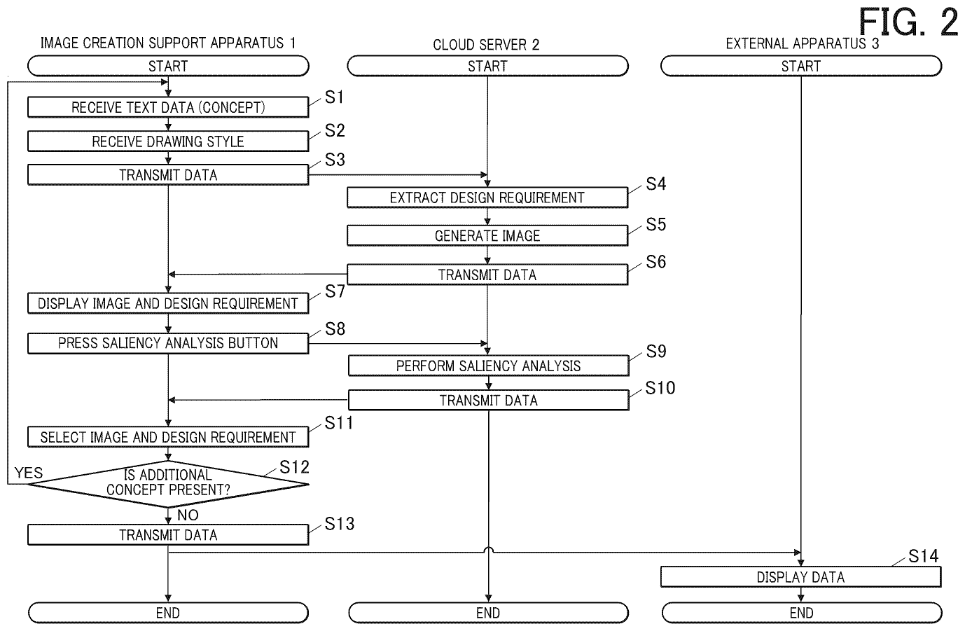

Next, an image creation support process will be described with reference to FIG. 2.

The image creation support process is a process for supporting image creation by a user, such as a salesperson of a printing company or a customer thereof, on the basis of the concept of text data input by the user. In the end, created image data, concept(s), and design requirements are transmitted to the designer's terminal (external apparatus 3).

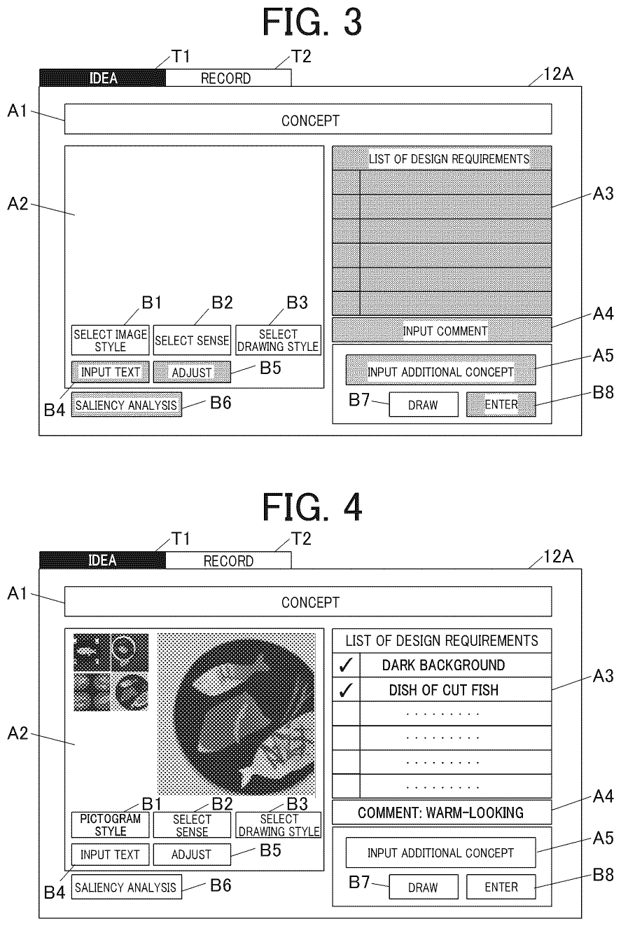

It is assumed that an image creation support screen 12A shown in FIG. 3 is initially displayed by the display part 12.

Before the image creation support process is described, screens that are displayed by the display part 12 will be described.

The image creation support screen 12A illustrated in FIG. 3 will be described.

The area A1 is an area where the user inputs a concept by text.

The area A2 is an area where an image generated by the cloud server 2 is displayed. The image generated by the cloud server 2 is a source image of a final design image, and may be generated to have at least one of a lower resolution, a lower number of gradations, and a lower number of colors than the final design image.

The area A3 is an area where design requirements extracted by the cloud server 2 from the concept are displayed.

The area A4 is an area where the user inputs comments.

The area A5 is an area where the user inputs an additional concept by text.

The button B1 is a button for selecting an image style of an image to be generated by the cloud server 2. For example, the image style is a pictogram style, an illustration style, or the like.

The button B2 is a button for selecting a sense to be felt from an image to be generated by the cloud server 2. For example, the sense is energetic, casual, elegant, or the like.

The button B3 is a button for selecting a drawing style of an image to be generated by the cloud server 2. The drawing style (drawing style information) is a feature of an image obtained by learning a past image group for the same customer. Specifically, in a case where a request to create a design image of a product label has been made by a customer in the past, the image generation AI of the cloud server 2 is caused to perform learning using an image in which only a character portion(s) of the design image has been deleted, and thus a feature of the image is obtained.

The button B4 is a button for inputting characters to an image displayed in the area A2.

The button B5 is a button for adjusting an image displayed in the area A2. For example, adjustment of an image refers to adjustment of the size, position, transparency, and the like of constituents of the image generated by the cloud server 2.

The button B6 is a button for performing saliency analysis of an image displayed in the area A2.

The button B7 is a button for drawing an image in the area A2 using various kinds of information input to the image creation support screen 12A.

The button B8 is a button for determining (fixing) an image displayed in the area A2.

When any of the buttons B1 to B6 is pressed, a pop-up screen is opened, and selection in a variety of aspects, input, analysis result display or the like is performed.

As illustrated in FIG. 3, in the initial display of the image creation support screen 12A, the area A1 and the buttons B1, B2, B3, B7 are active, and the user can perform text input or button press using the operation part 13.

FIG. 4 is the image creation support screen 12A after the button B7 is pressed, and an image generated by the cloud server 2 is displayed in the area A2. In the area A2, thumbnail images are displayed at the upper left, and an image corresponding to a selected thumbnail image is displayed at the right. In the area A3, a list of design requirements extracted by the cloud server 2 from text data on a concept input in the area A1. Removing a check mark displayed in the area A3 can remove the configuration of an image corresponding to the removed design requirement among the images in the area A2.

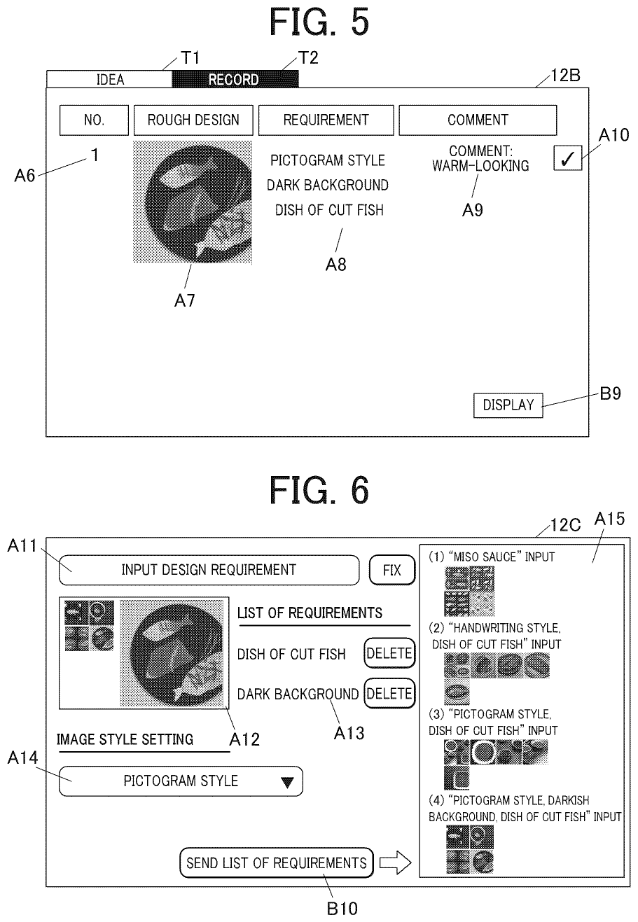

FIG. 5 is a record screen 12B, and a record is taken each time the button B7 is pressed.

The area A6 is an area where a record number is displayed.

The area A7 is an area where an image displayed in the area A2 is displayed.

The area A8 is an area where the design requirements displayed in the area A3 are displayed.

The area A9 is an area where comments input in the area A4 are displayed.

The area A10 is a checkbox for selecting a record to be displayed by the display part 12.

The button B9 is a button for displaying a record checked in the area A10 by the display part 12. When the button B9 is pressed, the image creation support screen 12A is displayed by the display part 12.

The image creation support screen 12A and the record screen 12B are switched by switching selection of tabs T1 and T2.

The description of the image creation support process will be restarted.

First, a user inputs a concept in the area A1 by text using the operation part 13. The controller 11 receives the input text data (Step S1, first reception). Text data input by text to the area A1 being received is not a limitation, and text data may be received from an external apparatus (e.g., a user terminal).

Next, the user presses the button B3 using the operation part 13 to cause the display part 12 to display a popup screen, and selects an image indicating a drawing style displayed on the popup screen. The controller 11 receives the selected drawing style (Step S2, drawing style information reception). Note that, although a drawing style is described as an example here, an image style or a sense may be used.

Next, the user presses the button B7 using the operation part 13. The controller 11 transmits the data received in Step S1 and Step S2 to the cloud server 2 via the network N (Step S3, first transmission).

Next, the controller 21 extracts design requirements using the date received via the network N (Step S4).

Next, the controller 21 generates an image by the image generation AI using the data received via the network N and the design requirements (Step S5).

Next, the controller 21 transmits the design requirements extracted in Step S4 and the image generated in Step S5 to the image creation support apparatus 1 via the network N (Step S6, first image obtainment).

Next, the controller 11 causes the display part 12 to display the above-described image creation support screen 12A illustrated in FIG. 4 using the data received via the network N (Step S7, display).

The controller 11 also stores the data received via the network B in the storage section 15 as a record.

Next, the user presses the button B6 using the operation part 13. The controller 11 instructs the cloud server 2 via the network N to perform saliency analysis of the image (Step S8). Note that in the present example, since the cloud server 2 has both the function as the image generation AI and the function as the saliency analysis module, the controller 11 instructs the cloud server 2 to perform saliency analysis of the image generated by the cloud server. If the saliency analysis module is a separate apparatus from the cloud server 2, the controller 11 transmits the image date to the saliency analysis module (Step S8, third transmission).

Next, the controller 21 performs saliency analysis of the image generated in Step S5 (Step S9).

Next, the controller 21 transmits the saliency analysis data to the image creation support apparatus 1 via the network N (Step S10, saliency analysis result obtainment).

The controller 11 causes the saliency analysis result to be displayed in a pop-up manner using the data received via the network N.

Next, in the image creation support screen 12A illustrated in FIG. 4, the user selects an image in the area A2 and selects (checks/check-deletes) a design requirement(s) in the area A3. The controller 11 receives selection of an image and a design requirement(s) (Step S11, image selection).

Constituents of an image(s) displayed in the area A2 correspond to respective design requirements, and when the user selects or deletes a design requirement, the controller 11 deletes or restores a constituent corresponding to the design requirement from or into the image(s) displayed in the area A2.

Next, in the image creation support screen 12A illustrated in FIG. 4, if the user has an additional concept (Step S12; YES), the user inputs the additional concept by text in the area A5. The controller 11 advances the image creation support process to Step S1.

In the second and subsequent loops of the image creation support process, in Step S3, the controller 11 may also transmit data of the image displayed in the area A2, the design requirements, and the like (in association). In the second and subsequent loops of the image creation support process, the “first” reception step, the “first” transmission step, and the “first” image obtainment step may be read as the “second”, “third” or the like.

If the user has no additional concept (Step S12; NO), the user presses the button B8. Upon receiving the press on the button B8, the controller 11 advances the image creation support process to Step S13.

Next, the controller 11 transmits the various data input or displayed to or on the image creation support screen 12A to the external apparatus 3 via the network N (Step S13, external apparatus transmission).

Next, the controller 31 receives the various data via the network N, and causes the display part 32 to display these (Step S14).

The various data include not only the image but also the concept(s), design requirements (including not only essential requirements but also forbidden requirements), saliency, image style, sense, drawing style, record, customer's impression comments on the generated image, and the like, so that the designer can understand the direction of the design.

### Others

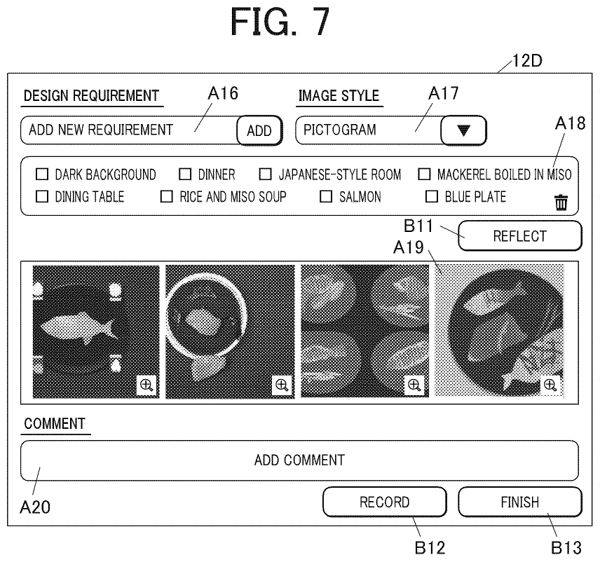

The image creation support screen may be a screen such as an image creation support screen 12C shown in FIG. 6 or an image creation support screen 12D shown in FIG. 7.

In the image creation support screen 12C illustrated in FIG. 6, when the user directly inputs a design requirement in the area A11 and presses a fixing button adjacent on the right, the controller 11 adds the design requirement to the list in the area A13.

Further, in the image creation support screen 12C illustrated in FIG. 6, when the user presses a button B10, the listed design requirements are transmitted to the cloud server 2, and the controller 31 generates an image.

Further, in the image creation support screen 12C illustrated in FIG. 6, since records (history) as in the area A15 (design requirements and images are changed in order of (1), (2), (3) and (4)) are displayed on the same screen, the user can easily follow change in design requirement and in image.

In the image creation support screen 12D illustrated in FIG. 7, when the user directly inputs a design requirement in the area A16 and presses an addition button adjacent on the right, the design requirement is added to the list of design requirements in the area A18. In the area A18, checkboxes and a trash box are provided, so that the user can select a design requirement(s) or delete a design requirement(s) itself. Further, the user can input comments in the area A20.

In the flow of the image creation support process illustrated in FIG. 2, when the button B8 (Enter) is pressed, the controller 11 transmits data to the external apparatus 3.

When the button B8 (Enter) is pressed, the controller 11 may transmit data to the cloud server 2 as determined data. Then, the controller 21 may transmit data to the external apparatus 3 on the basis of an obtainment instruction from the external apparatus 3 to the cloud server 2.

The text data may be based on at least one of free description and selection from prepared texts.

Since the cloud server 2 has the function as the image generation AI, the cloud server 2 may have the following functions in addition to the function of generating an image from a text.

The cloud server 2 may obtain information on the user of the image creation support apparatus 1, obtain, from the storage section 23, usable learning data by identifying the user, and generate an image on the basis of the learning data.

The cloud server 2 may reflect the determined image result at the time of generating an image next time.

The cloud server 2 may avoid imitation of already existing images by daringly generating learning data with low purity or by determining the degree of similarity and excluding data with a predetermined degree of similarity or more.

Although the image creation support process has been described above with the image creation support apparatus 1 and the cloud server 2 as separate apparatuses, the image creation support apparatus 1 may be provided with various functions of the cloud server 2 so that the image creation support process is executed in the image creation support apparatus 1.

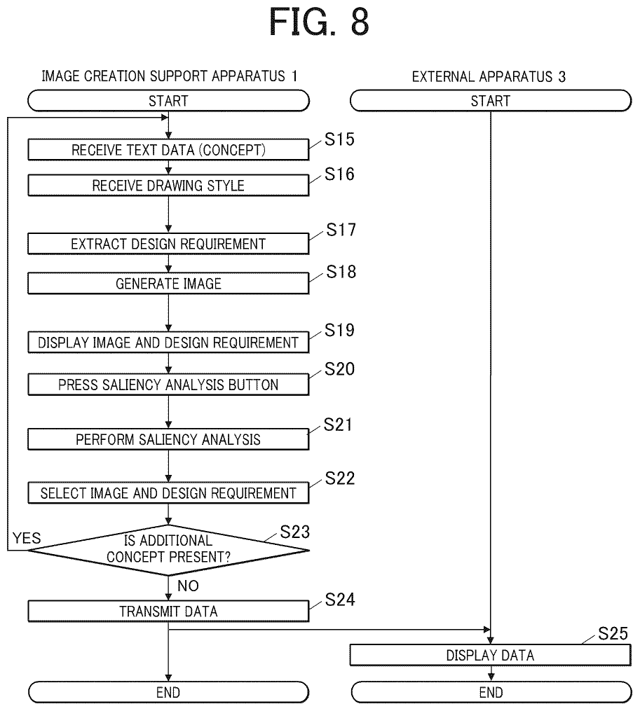

The flow of the image creation support process in this case is illustrated in FIG. 8. The processing content of each step is the same as each step of the image creation support process illustrated in FIG. 2, but transmission and reception of data between the image creation support apparatus 1 and the cloud server 2 is unnecessary.

### Effects

As described above, a non-transitory computer-readable storage medium stores a program causing a computer of the image creation support apparatus 1 to perform: first reception (Step S1) of receiving first text data; first transmission (Step S3) of transmitting the first text data to an image generation AI apparatus; first image obtainment (Step S6) of obtaining, from the image generation AI apparatus, first image data for the first text data, the first image data being generated by the image generation AI apparatus; and external apparatus transmission (Step S13) of transmitting the first text data and the first image data associated with one another to an external apparatus.

Therefore, it is possible to more efficiently create an image meeting the customer's request.

In addition, even in a case where the customer's request is ambiguous and he/she has no specific mental picture, it is possible to efficiently create an image by eliciting the customer's request. That is, the customer can make clear his/her mental picture by viewing a created image(s) while having a conversation with the salesperson. In addition, the salesperson can form a consensus with the customer having common knowledge of the mental picture in the end.

Further, the program stored in the non-transitory computer-readable storage medium further causes the computer to perform second reception (Step S1) of receiving second text data as a comment on the first image data, and the external apparatus transmission includes transmitting the first text data, the first image data and the second text data associated with one another to the external apparatus.

Therefore, it is possible to more efficiently brush up an image that meets the customer's request.

Further, the program stored in the non-transitory computer-readable storage medium further causes the computer to perform: second transmission (Step S3) of transmitting the first image data and the second text data to the image generation AI apparatus; and second image obtainment (Step S6) of obtaining second image data for the first image data and the second text data from the image generation AI apparatus, and the external apparatus transmission includes transmitting the first text data, the first image data, the second text data and the second image data associated with one another to the external apparatus.

Therefore, it is possible to more efficiently brush up an image that meets the customer's request.

Further, the program stored in the non-transitory computer-readable storage medium further causes the computer to perform third reception (Step S1) of receiving third text data as a comment on the second image data, and the external apparatus transmission includes transmitting the first text data, the first image data, the second text data, the second image data and the third text data associated with one another to the external apparatus.

Therefore, it is possible to more efficiently brush up an image that meets the customer's request.

Further, the external apparatus transmission is transmission based on an obtainment instruction from the external apparatus.

Therefore, the designer can receive data at any timing.

Further, the text data is based on at least one of free description and selection from a prepared text(s).

Therefore, the usability of the screen is improved.

Further, the program stored in the non-transitory computer-readable storage medium further causes the computer to perform display (Step S7) of causing a display (display 12) to display an obtained design requirement(s) extracted from the text data by the image generation AI apparatus.

Therefore, the customer can easily check the design requirement(s) as the main point from the concept.

Further, deletion is selectable for each of the displayed design requirement(s).

Therefore, the customer can easily select a design requirement(s) that the customer wants to use.

Further, the first image data obtained in the first image obtainment includes a plurality of images, the program stored in the non-transitory computer-readable storage medium further causes the computer to perform: display (Step S7) of causing a display (display part 12) to display the plurality of images; and image selection (Step S11) of allowing a user to select a desired image from among the displayed plurality of images, and in the external apparatus transmission, the selected desired image is transmitted as the first image data.

Therefore, it is possible to more efficiently create an image meeting the customer's request.

Further, the program stored in the non-transitory computer-readable storage medium further causes the computer to perform drawing style information reception (Step S2) of receiving an input of drawing style information.

Therefore, it is possible to more efficiently create an image meeting a drawing style desired by the customer.

Further, the drawing style information is image feature data obtained by learning a past image group for an identical customer.

Therefore, it is possible to more efficiently create an image meeting a drawing style desired by the customer.

Further, the first image data is image data that is a source of a final design image, and is image data being lower in at least one of resolution, the number of gradations and the number of colors than the final design image.

Therefore, it is possible to prevent imitation of already existing images.

Further, the program stored in the non-transitory computer-readable storage medium further causes the computer to perform: third transmission (Step S8) of transmitting the first image data to a saliency analysis apparatus; saliency analysis result obtainment (Step S10) of obtaining a saliency analysis result of the first image data from the saliency analysis apparatus; and display (Step S10) of causing a display (display part 12) to display the obtained saliency analysis result.

Therefore, it is possible to easily and objectively evaluate the saliency of a generated image.

Further, the image creation support system 100 includes a hardware processor (controller 11) that receives first text data; and a transmitter (communication part 14) that transmits the first text data to an image generation AI apparatus, the hardware processor obtains, from the image generation AI apparatus, first image data for the first text data, the first image data being generated by the image generation AI apparatus, and the transmitter transmits the first text data and the first image data associated with one another to an external apparatus.

Therefore, it is possible to more efficiently create an image meeting the customer's request.

Further, the image creation support method is an image creation support method that is performed by an image creation support system, and includes receiving first text data (Step S1); transmitting the first text data to an image generation AI apparatus (Step S3); obtaining, from the image generation AI apparatus, first image data for the first text data, the first image data being generated by the image generation AI apparatus (Step S6); and transmitting the first text data and the first image data associated with one another to an external apparatus (Step S13).

Therefore, it is possible to more efficiently create an image meeting the customer's request.

Further, the image creation support apparatus 1 includes a first reception section (controller 11) that receives first text data, a first image obtainment section (controller 11) that obtains first image data for the first text data, the first image data being generated by using the image generation AI, and an external apparatus transmission section (communication part 14) that transmits the first text data and the first image data associated with one another to an external apparatus.

Therefore, it is possible to more efficiently create an image meeting the customer's request.

Although the present invention has been specifically described on the basis of one or more embodiments above, it is needless to say that the present invention is not limited to the above-described embodiments and can be appropriately changed without departing from the scope thereof.

For example, in the above description, an example in which a hard disk, a semiconductor nonvolatile memory, or the like is used as the computer-readable medium of the program(s) according to the present invention has been disclosed, but the present invention is not limited to this example. As the computer-readable medium, a portable recording medium such as a CD-ROM can be applied.

The other detailed configuration/components and operation of each apparatus can be appropriately changed without departing from the scope of the invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-161803, filed on Sep. 26, 2023, including description, claims, drawings and abstract is incorporated herein by reference.

What is claimed is:

1. A non-transitory computer-readable storage medium storing a program causing a computer to perform:
first reception of receiving first text data;
first transmission of transmitting the first text data to an image generation AI apparatus;
first image obtainment of obtaining, from the image generation AI apparatus, first image data for the first text data, the first image data being generated by the image generation AI apparatus; and
external apparatus transmission of transmitting the first text data and the first image data associated with one another to an external apparatus.

2. The non-transitory computer-readable storage medium according to claim 1, wherein the program further causes the computer to perform second reception of receiving second text data as a comment on the first image data,
wherein the external apparatus transmission includes transmitting the first text data, the first image data and the second text data associated with one another to the external apparatus.

3. The non-transitory computer-readable storage medium according to claim 2, wherein the program further causes the computer to perform:
second transmission of transmitting the first image data and the second text data to the image generation AI apparatus; and
second image obtainment of obtaining second image data for the first image data and the second text data from the image generation AI apparatus,
wherein the external apparatus transmission includes transmitting the first text data, the first image data, the second text data and the second image data associated with one another to the external apparatus.

4. The non-transitory computer-readable storage medium according to claim 3, wherein the program further causes the computer to perform third reception of receiving third text data as a comment on the second image data,
wherein the external apparatus transmission includes transmitting the first text data, the first image data, the second text data, the second image data and the third text data associated with one another to the external apparatus.

5. The non-transitory computer-readable storage medium according to claim 1, wherein the external apparatus transmission is transmission based on an obtainment instruction from the external apparatus.

6. The non-transitory computer-readable storage medium according to claim 1, wherein the first text data is based on at least one of free description and selection from a prepared text.

7. The non-transitory computer-readable storage medium according to claim 1, wherein the program further causes the computer to perform display of causing a display to display an obtained design requirement extracted from the first text data by the image generation AI apparatus.

8. The non-transitory computer-readable storage medium according to claim 7, wherein deletion is selectable for each of the displayed design requirement.

9. The non-transitory computer-readable storage medium according to claim 1,
wherein the first image data obtained in the first image obtainment includes a plurality of images,
wherein the program further causes the computer to perform:
display of causing a display to display the plurality of images; and
image selection of allowing a user to select a desired image from among the displayed plurality of images, and,
wherein in the external apparatus transmission, the selected desired image is transmitted as the first image data.

10. The non-transitory computer-readable storage medium according to claim 1, wherein the program further causes the computer to perform drawing style information reception of receiving an input of drawing style information.

11. The non-transitory computer-readable storage medium according to claim 10, wherein the drawing style information is image feature data obtained by learning a past image group for an identical customer.

12. The non-transitory computer-readable storage medium according to claim 1, wherein the first image data is image data that is a source of a final design image, and is image data being lower in at least one of resolution, the number of gradations and the number of colors than the final design image.

13. The non-transitory computer-readable storage medium according to claim 1, wherein the program further causes the computer to perform:
third transmission of transmitting the first image data to a saliency analysis apparatus;
saliency analysis result obtainment of obtaining a saliency analysis result of the first image data from the saliency analysis apparatus; and
display of causing a display to display the obtained saliency analysis result.

14. An image creation support system comprising:
a hardware processor that receives first text data; and
a transmitter that transmits the first text data to an image generation AI apparatus,
wherein the hardware processor obtains, from the image generation AI apparatus, first image data for the first text data, the first image data being generated by the image generation AI apparatus, and
wherein the transmitter transmits the first text data and the first image data associated with one another to an external apparatus.

15. An image creation support method that is performed by an image creation support system, comprising;
receiving first text data;
transmitting the first text data to an image generation AI apparatus;
obtaining, from the image generation AI apparatus, first image data for the first text data, the first image data being generated by the image generation AI apparatus; and
transmitting the first text data and the first image data associated with one another to an external apparatus.
